(19) United States
(12) Patent Application Publication
(10) Pub. No.: US 2024/0418552 A1
(43) Pub. Date: Dec. 19, 2024

(54) METHOD FOR DETERMINING A GAS PHASE MASS FRACTION AND/OR GAS PHASE MASS FLOW RATE OF A MULTI-PHASE MEDIUM WITH A LIQUID PHASE AND A GAS PHASE FLOWING IN A MEASURING TUBE, AND MEASURING SENSOR THEREFOR

(71) Applicant: Endress+Hauser Flowtec AG, Reinach (CH)

(72) Inventors: Rainer Höcker, Waldshut (DE); Carsten Hersberger, Basel (CH)

(21) Appl. No.: 18/704,885

(22) PCT Filed: Oct. 25, 2022
(86) PCT No.: PCT/EP2022/079814

§ 371 Date: Apr. 25, 2024

(30) Foreign Application Priority Data
Oct. 26, 2021 (DE) 10 2021 127 850.3

(51) Int. Cl. G01F 1/74; G01F 1/36; G01F 1/44; G01F 1/88; G01F 15/04

(52) U.S. Cl. CPC G01F 1/74; G01F 1/363; G01F 1/44; G01F 1/88; G01F 15/043

(57) ABSTRACT

A method for determining a gas phase mass fraction or mass flow rate of a multi-phase medium flowing in a measuring tube, which includes a break-away edge exposed to the flow and three pressure taps, each influenced differently by the break-away edge, the method including: determining a first pressure drop between the first and second pressure taps; determining a second pressure drop between the third pressure tap and one of the first or second pressure taps; and determining the mass fraction or mass flow rate of the gas phase from the first and second pressure drops, the first pressure tap arranged upstream of the break-away edge and both the second and third pressure taps downstream thereof, one normal vector substantially axis-parallel to the second pressure tap and one normal vector perpendicular to the third pressure tap, the second pressure tap point positioned at or close to a pressure minimum.

The present invention relates to a method for determining a mass fraction of the gas phase of a multi-phase medium flowing in a measuring tube with a liquid phase and a gas phase and to a measuring transducer therefor.

It is known to characterize a mass flow of a multi-phase medium by means of differential pressure measurements, as disclosed, for example, in U.S. Pat. No. 2011/0259119 A1, which teaches a determination of a Lockhart-Martinelli parameter by measuring two pressure drops in a V-cone arrangement, wherein the first measurement includes the V-cone tip, and the second measurement takes place at a distance of multiple tube diameters downstream of the V-cone.

On the one hand, the teaching of the above-mentioned prior art reduces the measurement accuracy and, on the other hand, it requires large designs of the measuring assembly. The object of the present invention is, therefore, to find a remedy here. The object is achieved according to the invention by the method according to independent claim 1 and the device according to independent claim 9.

The method according to the invention is used to determine a mass fraction and/or mass flow rate of the gas phase of a multi-phase medium flowing in a measuring tube with a liquid phase and a gas phase, wherein the measuring tube has, for example, a steam, in particular saturated steam, wherein the measuring tube has a break-away edge exposed to an incident flow from the medium and at least three pressure tap points, wherein the break-away edge differently influences the flow of the medium at the at least three pressure tap points, wherein the method comprises: determining a first pressure drop between a first and second of the at least three pressure tap points which are each impinged by the flowing medium; determining a second pressure drop between two pressure tap points which are each impinged by the flowing medium, wherein one of the pressure tap points for determining the second pressure drop is a third of the at least three pressure tap points; and determining a value of the mass fraction of the gas phase and/or a value of the mass flow rate of the gas phase as a function of the first pressure drop and the second pressure drop, wherein the first pressure tap point is arranged upstream of the break-away edge in the direction of flow of the medium, wherein both the second pressure tap point and the third pressure tap point are positioned downstream of the break-away edge relative to the direction of flow,
wherein the second pressure tap point is arranged in a surface portion of a solid body, the normal vector of which encloses an angle of not more than 30°, for example not more than 15° and in particular not more than 5°, with a longitudinal axis of the measuring tube, and wherein the third pressure tap point is arranged in a surface portion of a solid body, the normal vector of which encloses an angle of not more than 20°, for example not more than 10°, and in particular not more than 5°, with a cross section through the measuring tube at the location of the third pressure tap point, wherein the second pressure tap point is positioned at or near the position of a pressure minimum so that the pressure at the second pressure tap point is not more than 10%, in particular not more than 5% of the pressure drop between the first pressure tap point and the second pressure tap point above the pressure minimum.

The position of the pressure minimum can be, for example, in the center of the flow shadow of a V-cone or in the flow shadow of a radial step of a tube widening.

In a further development of the invention, the third pressure tap point is positioned in the direction of flow at or near the position of a pressure maximum, in particular the nearest pressure maximum, so that the pressure at the second pressure tap point is not more than 6%, in particular not more than 3% of the pressure drop between the first pressure tap point and the second pressure tap point below the pressure maximum. In particular, the pressure maximum can be positioned on the tube wall with little or no axial offset relative to the position of the pressure minimum.

In a further development of the invention, the value of the mass fraction of the gas phase and/or the mass flow rate is determined as a function of a strictly monotonic function of a ratio of the first pressure drop to the second pressure drop. This strictly monotonic function of the ratio of the first pressure drop to the second pressure drop can, for example, be the ratio itself, the logarithm thereof, or a difference between the two pressure drops divided by the sum of the two pressure drops. What exactly the function looks like is not important, as long as it defines a unique relationship to the quotient of the first pressure drop divided by the second pressure drop.

In connection with the present invention, first pressure drops and second pressure drops have been determined for different gas phase mass fractions of a gas/liquid mixture at different mass flow rates for different measuring transducer types; the quotients determined therefrom are dependent on the mass fraction of the gas phase and substantially independent of the flow rate. The mass fraction of the gas phase can thus be determined on the basis of the quotient or a function which is strictly monotonically dependent thereon.

In a further development of the invention, the method comprises determining the mass flow rate of the gas phase which is determined as a function of at least one of the pressure drops, a density value of the gas phase, and either the mass fraction of the gas phase or a strictly monotonic function of a ratio of the first pressure drop to the second pressure drop.

In this case, the mass flow rate can be expressed, for example, as the product of a base term which is proportional to the kinetic energy of the gas phase and of a loss factor which describes losses due to friction and vortex break-away. In this case, the base term depends on the pressure loss and the density value of the gas phase in a manner known per se. The base term is determined in particular as proportional to the root of the product of one of the pressure drops and a density value of the gas phase. Furthermore, the geometric ratios of the measuring transducer are included in the base term.

The loss factor is a function of the mass fraction of the gas phase or a strictly monotonic function of a ratio of the first pressure drop to the second pressure drop and is to be determined in a type-specific manner for different measuring transducers.

In a further development of the invention, the mass flow rate of the gas phase is further determined as a function of the Froude number of the gas phase. The Froude number also influences the loss factor and can be taken into account as an additional parameter in the type-specific determination of the loss factors.

In a further development of the invention, the density value of the gas phase is determined on the basis of an absolute pressure measurement and, if it is not saturated steam, on the basis of a temperature measurement, in particular at the first pressure tap point; at this position, the pressure measurement is not yet impaired by the effect of the break-away edge and should result in a representative pressure measured value for the gas phase in the measuring tube.

The above positioning achieves the greatest possible sensitivity for determining the mass fraction of the gas phase. Positions of the third pressure tap point at a distance of multiple diameters from the break-away edge, such as in U.S. Pat. No. 2011/0259119 A1, on the other hand, are far behind the maximum and thus sacrifice and measurement accuracy.

The displacement body can in particular be designed to be substantially rotationally symmetrical with respect to the longitudinal axis of the measuring tube and can in particular be designed as a V-cone.

The measuring transducer according to the invention for determining a mass fraction and/or mass flow rate of the gas phase of a multi-phase medium flowing in a measuring tube with a liquid phase and a gas phase, in particular for carrying out the method according to the invention, comprises: a measuring tube which has a measuring tube body with an inner lateral surface, which inner lateral surface defines a lumen for guiding the flowing medium, wherein the measuring tube has a longitudinal direction Z in which the medium is to be guided; a break-away edge arranged in the lumen; at least three pressure tap points whose positions are mutually different with respect to the break-away edge; multiple pressure sensors for detecting pressure measured values at one of the pressure tap points and/or for detecting pressure differences between in each case two of the pressure tap points; a measuring and operating circuit, which is configured to determine a first pressure drop between a first and second of the at least three pressure tap points which are each impinged by the flowing medium; to determine a second pressure drop between two pressure tap points which are each impinged by the flowing medium, wherein one of the pressure tap points for determining the second pressure drop is a third of the at least three pressure tap points; and to determine a value of the mass fraction and/or mass flow rate of the gas phase of the medium as a function of the first pressure drop and the second pressure drop assuming a multi-phase medium which contains a liquid phase and a gas phase, wherein the first pressure tap point is arranged upstream of the break-away edge relative to a measuring tube longitudinal direction in the direction of flow, wherein both the second pressure tap point and the third pressure tap point are positioned downstream of the break-away edge in the direction of flow, wherein the second pressure tap point is arranged in a surface portion of a solid body, the normal vector of which encloses an angle of not more than 30°, for example not more than 15° and in particular not more than 5°, with a longitudinal axis of the measuring tube, and wherein the third pressure tap point is arranged in a surface portion of a solid body, the normal vector of which encloses an angle of not more than 20°, for example not more than 10°, and in particular not more than 5°, with a cross section through the measuring tube at the location of the third pressure tap point, wherein the second pressure tap point is positioned at or near the position of a pressure minimum so that the pressure at the second pressure tap point is not more than 10%, in particular not more than 5% of the pressure drop between the first pressure tap point and the second pressure tap point above the pressure minimum, wherein the third pressure tap point (116) is located at approximately the same position in the measuring tube longitudinal direction as the second pressure tap point (114), wherein the second pressure tap point is positioned at or near the position of a pressure minimum for a flow Re=4000 with the tube diameter as the characteristic length so that the pressure at the second pressure tap point is not more than 10%, in particular not more than 5% of the pressure drop between the first pressure tap point and the second pressure tap point above the pressure minimum.

In a further development of the invention of the invention, the third pressure tap point is positioned in the direction of flow at or near the position of a local pressure maximum for a flow of Re=4000 with the tube diameter as the characteristic length so that the pressure at the second pressure tap point is not more than 6%, in particular not more than 3% of the pressure drop between the first pressure tap point and the second pressure tap point below the pressure maximum.

The invention is now explained in more detail on the basis of the exemplary embodiments shown in the figures, in which:

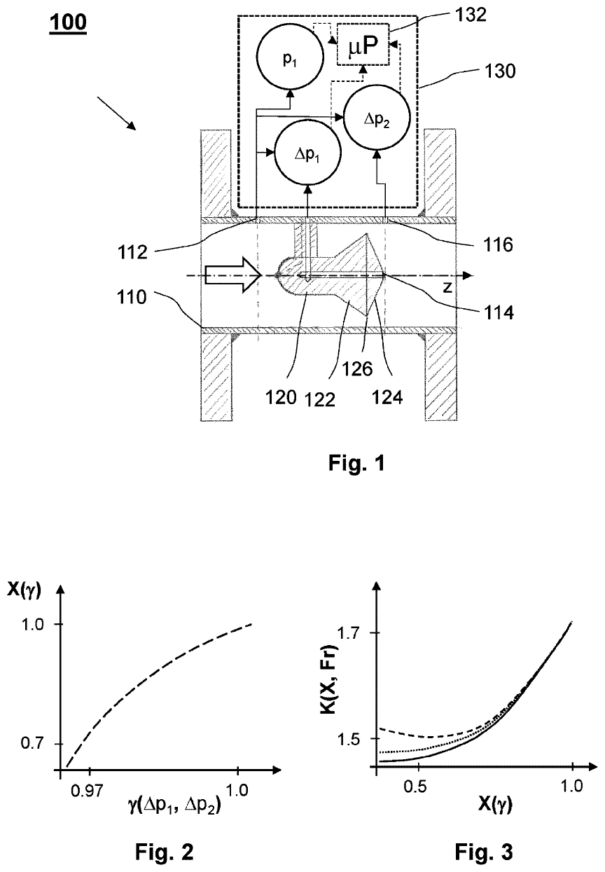

FIG. 1: shows a schematic representation of a first exemplary embodiment of a measuring transducer according to the invention;

FIG. 2: shows an exemplary diagram showing the mass fraction of the gas phase as a function of the quotient of the pressure drops;

FIG. 3: shows an exemplary diagram showing an attenuation factor as a function of the mass fraction of the gas phase and the Froude number;

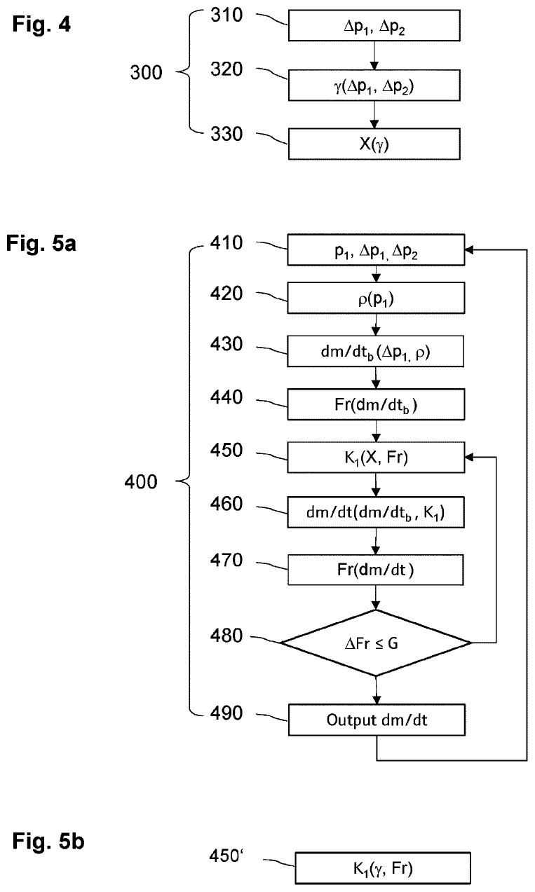

FIG. 4: shows a flowchart for an exemplary embodiment of the method for determining the mass fraction of the gas phase;

FIG. 5a: shows a flowchart for an exemplary embodiment of the method for determining the mass flow rate of the gas phase; and

FIG. 5b: shows a modification of the exemplary embodiment of the method for determining the mass flow rate of the gas phase.

The first exemplary embodiment of a measuring transducer 100 according to the invention shown in FIG. 1 comprises a cylindrical measuring tube 110 having a displacement body 120 mounted therein, which displacement body in this case is designed in the form of a so-called V-cone, i.e., the effective part of the displacement body 120 comprises a first cone portion 122 having a diameter increasing in the direction of flow or in the direction of the measuring tube longitudinal axis Z, and a second cone portion 124 adjoining thereto having a diameter decreasing in the direction of flow Z. The common circumference of the two cone portions 122, 124 forms a break-away edge 126 at which vortices of a medium flowing through the measuring tube 110 separate. The measuring transducer 100 has a first pressure tap point 112 upstream of the displacement body 120 in the direction of flow Z to which an absolute pressure measuring device p₁ is connected, which is at a distance of approximately one diameter of the measuring tube 110 from the break-away edge 126 and is largely unaffected by effects of the displacement body. A second pressure tap point 114 is located at the tip 11 of the second cone portion 124, i.e., in the flow shadow of the displacement body 120 on the axis of the measuring tube. A pressure minimum is to be expected at the location of the second pressure tap point 114. A third pressure point 116 is located on the wall of the measuring tube 110 downstream of the break-away edge 126 in the direction of flow. The third pressure tap point 116 is located at approximately the same position in the measuring tube longitudinal direction as the second pressure tap point 114.

A first differential pressure sensor Δp₁ and a second differential pressure sensor Δp₂, each detecting the pressure difference from the first pressure tap point, are connected to the second or third pressure tap point. The measuring transducer 100 further has a measuring and operating circuit 130 for operating the pressure sensors and for evaluating the measured values thereof by means of a microprocessor 132, in particular according to the method according to the invention.

The diagram in FIG. 2 shows as a dashed line the gas phase mass fraction of the total mass of the flowing medium as a function of a function γ(Δp₁, Δp₂) which is defined as γ(Δp₁, Δp₂)=(Δp₁/Δp₂)^{0.5}. To generate the curve, defined, non-condensable mass flows of a gas, in particular air, were mixed with defined mass flows of a liquid at room temperature at different flow rates to form a plurality of mass fractions X of the gas phase and passed through the measuring transducer to be characterized. The resulting pressure drops Δp₁, Δp₂ were detected. The specified mass fractions x were then modeled as a function of γ(Δp₁, Δp₂). The curve 4 shows a resulting fit for X (γ(Δp₁, Δp₂)). The corresponding model is stored in the measuring transducer, which makes it possible to determine the mass fraction of the gas phase during n measuring operation on the basis of the two pressure drops Δp₁, Δp₂. This is of particular interest for characterizing (saturated) steam flows, in particular in power plants.

To determine the mass flow rate of a flowing medium with a gas phase and a liquid phase based on a differential pressure measurement, a base mass flow rate which was determined under the assumption of a loss-free Bernoulli effect is to be multiplied by a correction factor which takes into account pressure losses as a function of the composition of the medium and the Froude number of the medium.

The diagram in FIG. 3 shows correction factors which have been experimentally determined for a measuring transducer to be characterized using defined mass flows with defined mass fractions of the gas phase. The dashed curve corresponds to a Froude number of 140, the dotted curve to a Froude number of 100, and the solid curve to a Froude number of 60.

The Froude number Fr was determined for the different mass flow rates according to:

$$F r = \frac{{c}_{sv , g}}{\sqrt{g \cdot h}}$$

The Froude number is formed at an empty tube velocity of the gas phase c_{sv,g} upstream of the flow obstacle and a gap height h, as a characteristic length. The empty tube velocity of the gas phase is determined under the assumption, from the mass flow 22 rate of the gas phase and its density under the assumption that the total tube cross section is available for the flowing gas phase. For example, for the first exemplary embodiment, the gap height results from the tube diameter and the diameter of the V-cone at the break-away edge.

$$h = \frac{{D}_{tube} - {D}_{V c o n e}}{2}$$

The base mass flow rate dm/dt_{g,b} of the gas phase according to Bernoulli is, for the measuring transducer of the first exemplary embodiment:

$${\dot{m}}_{g , b} = \frac{A}{\sqrt{1 - {β}^{4}}} \cdot \sqrt{2 \cdot ρ ( {p}_{1} ) \cdot Δ {p}_{1}}$$

A is the narrowest cross-sectional area, β is the diameter ratio of the measuring tube and V-cone, and ρ(p₁) is the density at the first pressure drop.

The actual mass flow rate of the gas phase is to be obtained from the base mass flow rate by multiplying by the correction factor K₁.

$${\dot{m}}_{g} = {K}_{1} ( x , Fr ) \cdot {\dot{m}}_{g , b}$$

Accordingly, when characterizing a measuring transducer, the correction factors K are to be determined based on predetermined actual mass flow rates and based on measured base mass flow rates according to:

$${K}_{1 ( x , F r )} = \frac{{\dot{m}}_{g}}{{\dot{m}}_{g , b}}$$

The correction factors determined are stored in a data memory of the measuring and operating circuit of a measuring transducer.

The methods according to the invention can be carried out using the measuring transducers described above and the determined data on their characterization, as described below.

The exemplary embodiment of a method 300 shown in FIG. 4 for determining the mass fraction of the gas phase of a two-phase medium, which contains a liquid phase and a gas phase and which, for example, flows through a measuring transducer according to FIG. 1, starts by detecting 310 a first pressure drop Δp₁ between a first pressure tap point and a second pressure tap point, and by detecting a second pressure drop Δp₂ between the first pressure tap point and a third pressure tap point. This is followed by determining 320 a strictly monotonic function γ(Δp₁, Δp₂) of the first pressure drop and the second pressure drop, which is given here as the root of the quotient Δp₁/Δp₂. In a final step 330, the mass fraction X (γ(Δp₁, Δp₂) is determined base on a stored model, as shown, for example, in FIG. 2.

The exemplary embodiment of a method 400 shown in FIG. 5 for determining the mass flow rate of the gas phase of a saturated steam, which contains a liquid phase (condensate) and a gas phase, and, for example, flows through a measuring transducer according to FIG. 1, starts by detecting 410 an absolute pressure p₁ at a first pressure tap point, which is unaffected by a flow obstacle, a first pressure drop Δp₁ between the first pressure tap point and a second pressure tap point, and a second pressure drop Δp₂ between the first pressure tap point and a third pressure tap point. This is followed by determining 420 the density of the gas phase ρ(p₁). In a saturated steam application, the density determination based on the pressure is sufficiently accurate; an additional temperature measurement at the first pressure tap point is optionally necessary for other media.

The presence of the density ρ(p₁) and the pressure drop Δp₁ meet the requirements for determining 430 a base mass flow rate for the gas phase according to Bernoulli:

$${\dot{m}}_{g , b} = \frac{A}{\sqrt{1 - {β}^{4}}} \cdot \sqrt{2 \cdot ρ ( {p}_{1} ) \cdot Δ {p}_{1}}$$

However, the base mass flow rate is not representative because the measured pressure drop Δp₁ is influenced by the second phase, in this case condensate. Determining a correction factor K₁ is first preceded by determining 440 the Froude number, which is determined on the basis of the base mass flow rate.

This is followed by determining 450 the correction factor K₁ as a function of the mass fraction X of the gas phase X and the Froude number, wherein the mass fraction X of the gas phase is determined as in the method according to FIG. 4. The correction factor K₁ is obtained from the determined input variables based on the modeled dependence, as shown by way of example in FIG. 3.

The actual mass flow rate dm/dt of the gas phase is obtained by multiplying 460 the base mass flow rate by the correction factor K₁.

On the basis of the actual mass flow rate dm/dt of the gas phase, the Froude number is determined again 470.

If a subsequent test 480 reveals that the Froude number deviates from the previously calculated Froude number by more than a limit value G, the method steps 450 ff are iteratively repeated until a newly determined Froude number deviates from the preceding Froude number by no more than the limit value G. An actual value of the mass flow rate is then output, and the method begins again with the detection of new input variables.

A modification shown in FIG. 5b of the method according to FIG. 5a relates to the determination of the correction factor K1. Said correction factor can also be calculated without explicitly determining the mass fraction X of the gas phase as a function of (γ(Δp₁, Δp₂) and the Froude number in a step 450′.

1-10. (canceled)

11. A method for determining a gas phase mass fraction, and/or a gas phase mass flow rate, of a multi-phase medium, including a liquid phase and a gas phase, flowing in a measuring tube, wherein the measuring tube includes a break-away edge exposed to an incident flow of the medium and at least three pressure tap points, which are each subjected to the flow, such that the break-away edge influences the flow differently at each of the at least three pressure tap points, the method comprising:
determining a first pressure drop between a first pressure tap point and a second pressure tap point of the at least three pressure tap points;
determining a second pressure drop between two of the at least three pressure tap points, wherein one of the two pressure tap points for determining the second pressure drop is a third pressure tap point of the at least three pressure tap points; and
determining a value of the mass fraction and/or the mass flow rate of the gas phase as a function of the first pressure drop and the second pressure drop,
wherein the first pressure tap point is arranged upstream of the break-away edge relative to a direction of flow of the medium, and
wherein both the second pressure tap point and the third pressure tap point are arranged downstream of the break-away edge relative to the direction of flow,
wherein the second pressure tap point is disposed in a first surface portion of a solid body, a normal vector of which encloses an angle of not more than 20° with a longitudinal axis of the measuring tube, and
wherein the third pressure tap point is disposed in a second surface portion of the solid body, a normal vector of which encloses an angle of not more than 20° with a cross-section through the measuring tube at the third pressure tap point,
wherein the third pressure tap point, in a direction of the measuring tube longitudinal axis, is arranged at approximately a same axial position as the second pressure tap point,
wherein the second pressure tap point is disposed at or near a pressure minimum in the flow such that a pressure at the second pressure tap point is not more than 10% of the first pressure drop above the pressure minimum.

12. The method according to claim 11, wherein the second pressure tap point is disposed such that the pressure at the second pressure tap point is not more than 5% of the first pressure drop above the pressure minimum.

13. The method according to claim 11, wherein the value of the mass fraction and/or mass flow rate of the gas phase is determined as a function of a strictly monotonic function of a ratio of the first pressure drop to the second pressure drop.

14. The method according to claim 11, further comprising determining the mass flow rate of the gas phase, which is determined as a function of at least one of the first and second pressure drops, a density value of the gas phase, and either the mass fraction of the gas phase or a strictly monotonic function of a ratio of the first pressure drop to the second pressure drop.

15. The method according to claim 14, wherein the mass flow rate of the gas phase is further determined as a function of the Froude number of the medium.

16. The method according to claim 14, wherein the mass flow rate is determined as proportional to the root of the product of one of the first and second pressure drops and a density value of the gas phase of the medium.

17. The method according to claim 16, wherein the density value of the gas phase is determined based on an absolute pressure measurement.

18. The method according to claim 16, wherein the density value of the gas phase is determined based on an absolute pressure measurement and a temperature measurement at the first pressure tap point.

19. The method according to claim 11, wherein the third pressure tap point is arranged downstream of the second pressure tap point in the direction of flow at or near a pressure maximum in the flow such that the pressure at the second pressure tap point is not more than 6% of the first pressure drop below the pressure maximum.

20. The method according to claim 19, wherein the pressure maximum is the nearest pressure maximum to the third pressure tap point, and wherein the pressure at the second pressure tap point is not more than 3% of the first pressure drop below the nearest pressure maximum.

21. The method according to claim 11, wherein a displacement body is disposed in the measuring tube,
wherein the break-away edge extends, in a cross-sectional plane of the measuring tube, with a maximum cross-sectional circumference of the displacement body.

22. The method according to claim 11, wherein the medium comprises saturated steam.

23. A measuring transducer for determining a mass fraction, and/or mass flow rate, of a gas phase of a multi-phase medium, including a liquid phase and a gas phase, flowing in a measuring tube, the measuring transducer comprising:
the measuring tube, which includes a measuring tube body having an inner lateral surface, which inner lateral surface defines a lumen for guiding the flowing medium, wherein the measuring tube has a longitudinal direction in which the medium is to flow;
a break-away edge disposed in the lumen;
at least three pressure tap points, which are each subjected to the flowing medium and whose positions are mutually different with respect to the break-away edge;
a plurality of pressure sensors configured to detect measured pressure values at one of the at least three pressure tap points, respectively, and/or configured to detect pressure differences between two of the at least three pressure tap points, respectively;
a measuring and operating circuit configured to determine:
a first pressure drop between a first pressure tap point and a second pressure tap point of the at least three pressure tap points;
a second pressure drop between two of the at least three pressure tap points, wherein one of the pressure tap points for determining the second pressure drop is a third pressure tap point of the at least three pressure tap points; and
a value of the mass fraction and/or mass flow rate of the gas phase of the medium as a function of the first pressure drop and the second pressure drop, wherein the measuring and operating circuit assumes the medium which contains a liquid phase and a gas phase,
wherein the first pressure tap point is arranged upstream of the break-away edge relative to the measuring tube longitudinal direction in the direction of flow, and
wherein both the second pressure tap point and the third pressure tap point are arranged downstream of the break-away edge in the direction of flow,
wherein the second pressure tap point is disposed in a first surface portion of a solid body, a normal vector of which encloses an angle of not more than 20° with a longitudinal axis of the measuring tube, and
wherein the third pressure tap point is disposed in a second surface portion of the solid body, a normal vector of which encloses an angle of not more than 20° with a cross-section through the measuring tube at the third pressure tap point,
wherein the third pressure tap point, in a direction of the measuring tube longitudinal axis, is arranged at approximately a same axial position as the second pressure tap point,
wherein the second pressure tap point is disposed at or near a pressure minimum in the flowing medium for a flow having a Reynolds number value equal to about 4000, using a diameter of the lumen as a characteristic length of the Reynolds number value, such that a pressure at the second pressure tap point is not more than 10% of the pressure drop above the pressure minimum.

24. The measuring transducer according to claim 23, wherein the second pressure tap point is disposed such that the normal vector of the first surface portion encloses an angle of not more than 5° with the longitudinal axis of the measuring tube.

25. The measuring transducer according to claim 23, wherein the third pressure tap point is disposed such that the normal vector of the second surface portion encloses an angle of not more than 5° with the cross-section through the measuring tube at the third pressure tap point.

26. The measuring transducer according to claim 23, wherein the second pressure tap point is disposed such that the pressure at the second pressure tap point is not more than 5% of the pressure drop above the pressure minimum.

27. The measuring transducer according to claim 22, wherein the third pressure tap point is disposed in the direction of flow at or near the local pressure maximum in the flowing medium for the flow having the Reynolds number value equal to about 4000 such that the pressure at the second pressure tap point is not more than 6% of the first pressure drop below the pressure maximum.

28. The measuring transducer according to claim 27, wherein the third pressure tap point is disposed such that the pressure at the second pressure tap point is not more than 3% of the first pressure drop below the pressure maximum.
